(19) United States
(12) Patent Application Publication
(10) Pub. No.: US 2017/0019337 A1
(43) Pub. Date: Jan. 19, 2017

(54) COMMUNICATION SYSTEM, COMMUNICATION METHOD AND CONTROL APPARATUS

(71) Applicant: NEC Corporation, Tokyo (JP)

(72) Inventor: Makoto FUJINAMI, Tokyo (JP)

(73) Assignee: NEC Corporation, Tokyo (JP)

(21) Appl. No.: 15/301,187

(22) PCT Filed: Mar. 19, 2015
(86) PCT No.: PCT/JP2015/001551

§ 371 Date: Sep. 30, 2016

(30) Foreign Application Priority Data
Mar. 31, 2014 (JP) 2014-071268

(51) Int. Cl. H04L 12/803; H04W 48/00; H04L 12/721

(52) U.S. Cl. CPC H04L 47/125; H04L 45/38; H04W 48/17

(57) ABSTRACT

A communication system, a communication method and a control apparatus are provided that can resolve an optimum path while taking consideration of network resources and the resources of packet processing nodes. Included are a plurality of nodes (N1 to N5) each having a routing function, at least one processing node (20a, 20b) performing processing of an arriving packet, and an upper-level control apparatus (30) that calculates an optimum path up to the processing node by using network load information collected from the network nodes and processing load information collected from the processing node, and performs path setting on each network node.

### TECHNICAL FIELD

The present invention is based upon and claims the benefit of priority from Japanese Patent Application No. 2014-071268, filed on Mar. 31, 2014, the disclosure of which is incorporated herein in its entirety by reference.

The present invention relates to a routing technique in a communication network.

### BACKGROUND ART

Routing in a network is in general a method of selecting an optimal path to a destination node by each node referring to a routing table. However, in recent years, OpenFlow technology, which implements routing in units of flows, has also attracted attention (NPL 1). The basic idea of OpenFlow technology is to separate data plane from control plane, which allow independent developments, respectively. This separated configuration changes switches from a closed system into a programmable open platform.

More specifically, in OpenFlow, a communication determined by a combination of identifiers such as physical port number (L1), MAC (Media Access Control) address (L2), IP address (L3) and port number (L4) is defined as a “flow”, and routing is implemented in units of flows. An OpenFlow switch (OFS) functioning as a forwarding node operates in accordance with a flow table, which is added or rewritten in accordance with an instruction from an OpenFlow controller (OFC). A flow table includes, for each flow, a rule, statistical information and an action which defines the processing to be applied to a packet that matches the rule.

### CITATION LIST

### Non-Patent Literature

[NPL 1]
OpenFlow Specification Version 1.3.2 (Wire Protocol 0x04) Apr. 25, 2013 <URL https://www.opennetworking.org/images/stories/downloads/sdn-resources/onf-specifications/openflow/openflow-spec-v1.3.2.pdf>

### SUMMARY

### Technical Problem

However, according to the above-described routing method, no consideration is given to the loaded state of a server to process packets for routing. Accordingly, it is impossible to perform routing appropriate to circumstances such as, for example, a case where a path to a server is heavily loaded but the server is lightly loaded, or a case where, conversely, a path to a server is lightly loaded but the server is heavily loaded. In other words, it is impossible to resolve an optimum path while taking a bird's-eye view of the network resources for paths and the server resources for processing.

Accordingly, an object of the present invention is to provide a communication system, a communication method and a control apparatus that can resolve an optimum path, taking into consideration the resources of a network and the resources of packet processing nodes.

### Solution to Problem

A communication system according to the present invention is a communication system that performs routing in a network, characterized by including: a plurality of network nodes, each of which has a routing function; at least one processing node that processes an arriving packet; and an upper-level control apparatus that uses network load information collected from the network nodes and processing load information collected from the processing node to calculate an optimum path up to the processing node, and performs path setting on each network node.

A control apparatus according to the present invention is a control apparatus performing routing in a network, characterized by including: a storage means for storing network load information collected from a plurality of network nodes, each of which has a routing function, and processing load information collected from at least one processing node, which processes an arriving packet; and a control means that uses the network load information and the processing load information to calculate an optimum path up to the processing node, and performs path setting on each network node.

A communication method according to the present invention is a communication method for performing routing in a network, wherein the network includes a plurality of network nodes, each of which has a routing function, and at least one processing node that processes an arriving packet, characterized by comprising: by a path calculation means, calculating an optimum path up to the processing node by using network load information collected from the network nodes and processing load information collected from the processing node; and by a path setting means, performing path setting on each network node according to the optimum path.

### Advantageous Effects of Invention

According to the present invention, it is possible to set up an optimum path while taking consideration of the network resources and the resources of packet processing nodes.

### BRIEF DESCRIPTION OF DRAWINGS

FIG. 1 is a schematic diagram showing an example of a communication system according to an exemplary embodiment of the present invention.

FIG. 2 is a block diagram showing the more detailed configurations of network nodes and a upper-level control apparatus according to the present exemplary embodiment.

FIG. 3 is a flowchart showing overall operation in the system according to the present exemplary embodiment.

FIG. 4 is a schematic diagram showing an example of a network to which a communication system according to an example of the present invention is applied.

FIG. 5 is a sequence diagram showing overall operation in the system according to the present example.

### DETAILED DESCRIPTION

### Outline of an Exemplary Embodiment

According to an exemplary embodiment of the present invention, path load information for routing and processing load information on a processing node that processes a packet arriving as a result of routing are acquired, whereby it is possible to perform routing with integrative consideration given to the network resources on a path from the source of the packet to the processing node and to the processing resources of this processing node, allowing the resource use efficiency to be maximized. Hereinafter, the exemplary embodiment and an example of the present invention will be described with reference to drawings.

### 1. Exemplary Embodiment

### 1.1) Communication System

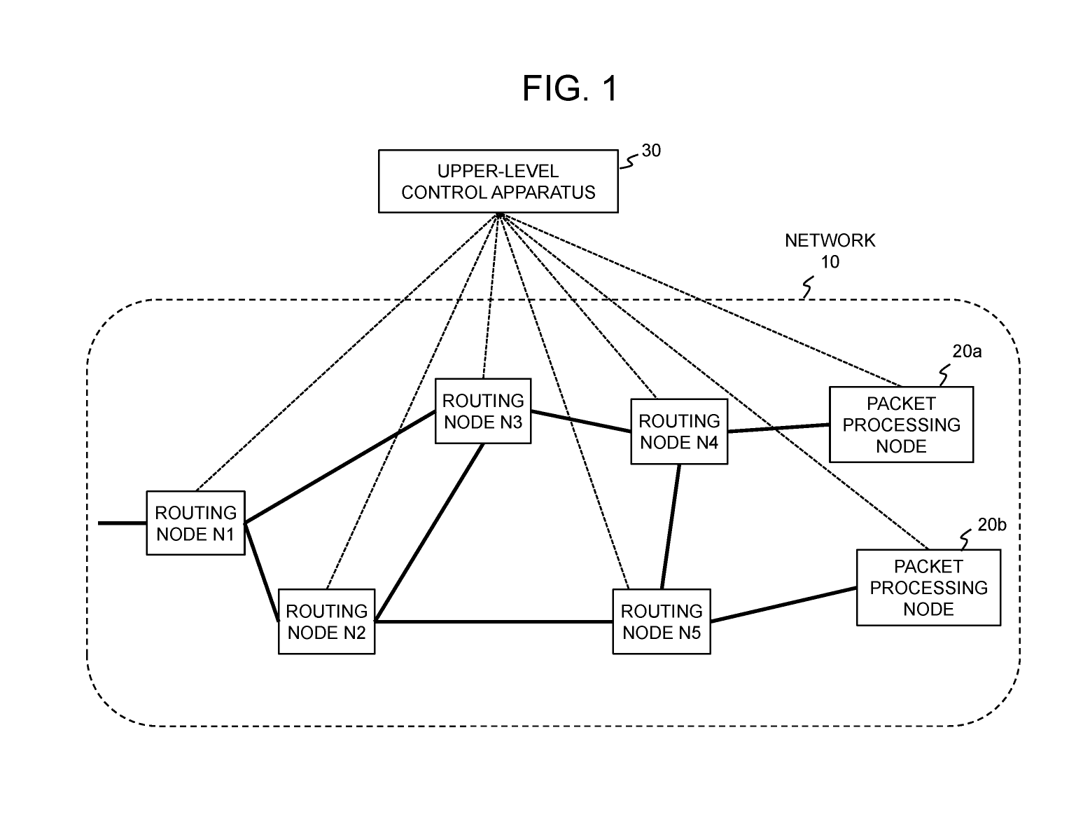

As shown in FIG. 1, an architecture will be taken as an example in which a network 10 includes a plurality of routing nodes N1 to N5 and a plurality of packet processing nodes 20a and 20b, and each node in the network 10 is connected to an upper-level control apparatus 30. However, the network architecture shown in FIG. 1 is an example to avoid complexity in description of a communication system according to the exemplary embodiment of the present invention.

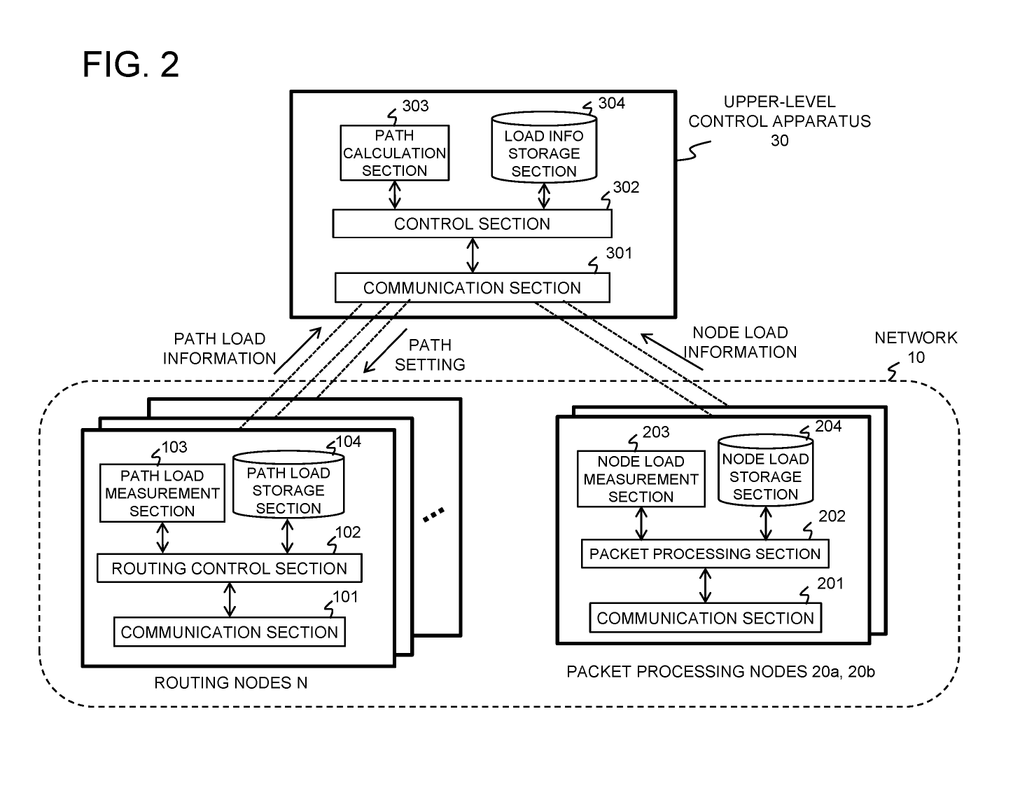

Referring to FIG. 1, the upper-level control apparatus 30 collects path load information from each of the routing nodes N1 to N5 and further collects packet processing load information from the packet processing nodes 20a and 20b. The upper-level control apparatus 30 uses the path load information and packet processing load information to calculate an optimum path for a packet to arrive at the packet processing node 20a or 20b, and makes setting of this optimum path on each of the routing nodes N1 to N5. Accordingly, it is possible to perform packet routing with consideration given to not only the path loads but also the processing loads. The more detailed apparatus configurations are shown in FIG. 2.

Referring to FIG. 2, each routing node N (N1 to N5) is a node provided at each branching point in the network 10 and having a routing function, and includes a communication section 101 for communicating with other nodes in the network 10 and the upper-level control apparatus 30, a routing control section 102, a path load measurement section 103 and a path load storage section 104. The communication section 101 of each routing node N establishes, for example, a session with the upper-level control apparatus 30 all the time to send path load information on path and network loads and to receive path setting information. The routing control section 102 performs routing in accordance with the path setting information from the upper-level control apparatus 30. The path load measurement section 103 measures network loads such as the usage rate of the bandwidth in the network and packet delays or losses occurring in the network and stores them in the path load storage section 104.

Each of the packet processing nodes 20a and 20b is a processing apparatus that processes a packet arriving at the own node as its destination, such as a server that sends some service back in response to the arriving packet. The packet processing nodes 20a and 20b each include a communication section 201 for communicating with other nodes in the network 10 and the upper-level control apparatus 30, a packet processing section 202, a node load measurement section 203 and a node storage section 204. The node load measurement section 203 measures node loads such as the CPU usage of the own node and the network interface usage and stores them in the node load storage section 203. Note that the packet processing nodes 20a and 20b need not necessarily be physical apparatuses but may be servers configured by means of virtual machine (VM).

The upper-level control apparatus 30 is an upper-level apparatus that makes path setting on each routing node N in the network 10, and includes a communication section 301 for communicating with the routing nodes N and packet processing nodes 20a and 20b in the network 10, a control section 302, a path calculation section 303 and a load information storage section 304. The load information storage section 304 stores the path load information collected from each of the routing nodes N1 to N5 and the packet processing load information collected from the packet processing nodes 20a and 20b, and the path calculation section 303 uses these load information to calculate an optimum path for a packet to arrive at the packet processing node 20a or 20b. The control section 302 subsequently notifies path setting information on the optimum path to each routing node N.

Note that it is also possible that the above-described routing nodes N, packet processing nodes 20a and 20b and upper-level control apparatus 30 each include a storage device for storing the respective programs and a computer (CPU), and the above-described respective functions are implemented by executing the respective programs on the respective computers.

### 1.2) Operation

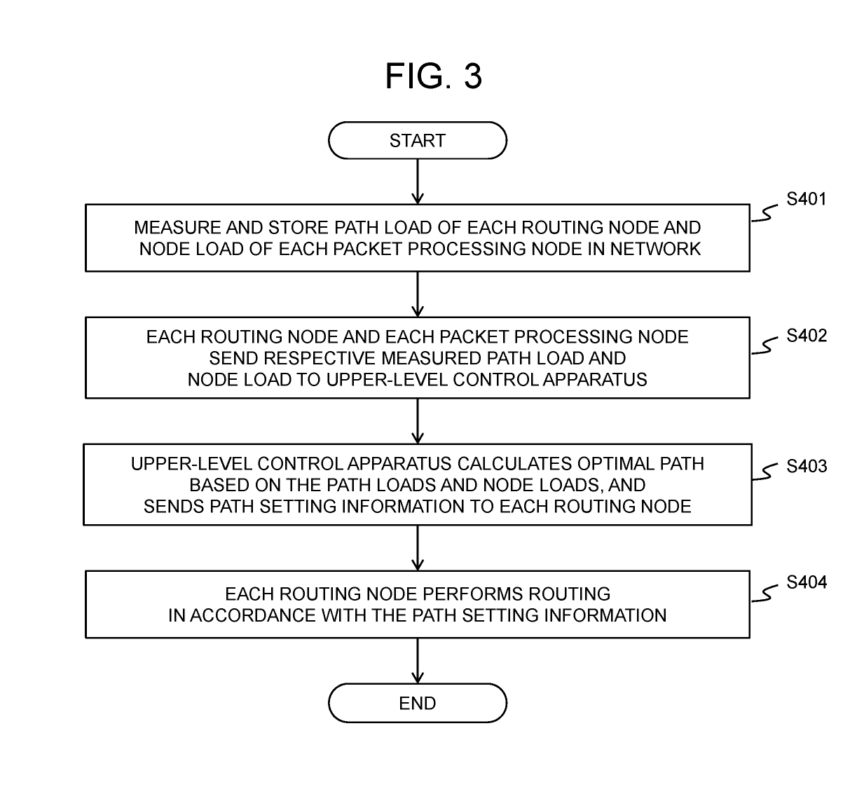

Referring to FIG. 3, the path load measurement section 103 of each routing node N measures the above-described network loads and stores them in the path load storage section 104, while the node load measurement section 203 of each of the packet processing nodes 20a and 20b measures the node loads and stores them in the node load storage section 204 (Operation S401). Note that the network load information to be acquired by the routing nodes N and the node load information to be acquired by the packet processing nodes 20a and 20b may be collected and stored periodically, or may be collected and stored in accordance with an instruction from the upper-level control apparatus 30.

Subsequently, each routing node N sends the path load information stored in the path load storage section 104 to the upper-level control apparatus 30, while each of the packet processing nodes 20a and 20b sends the node load information stored in the node load storage section 204 to the upper-level control apparatus 30 (Operation S402). Note that the collection of the load information by the upper-level control apparatus 30 may be triggered by the occurrence of a connection request packet, or the upper-level control apparatus 30 may collect by periodically requesting the load information from each node.

The upper-level control apparatus 30 uses the path load information and node load information received from the routing nodes and packet processing nodes, respectively, to calculate an optimum path up to a packet processing node and, following the optimum path, sends path setting information to each routing node (Operation S403). Each routing node having received the path setting information performs routing in accordance with the path setting information (Operation S404).

Next, overall operation in the present exemplary embodiment will be described, taking the network 10 shown in FIG. 1 as an example. Here, it is assumed that the packet processing nodes 20a and 20b are servers providing the same service, and that the packet processing node 20a is in a state under a heavier processing load while the packet processing node 20b is in a state under a lighter processing load. In this circumstance, it is assumed that a connection request packet addressed to a packet processing node providing this service has arrived at the routing node N1. The upper-level control apparatus 30, upon knowing the arrival of the connection request packet from the routing node N1, calculates an optimum path from the routing node N1 to the packet processing node 20b under a lighter processing load, based on the path load information and node load information collected from the network 10 as described above, and then performs path setting on each routing node.

### 1.3) Effects

As described above, according to the present exemplary embodiment, it is possible to optimize a path from the source of a packet to a packet processing node having capacity to spare for processing load, and to perform routing with integrative consideration given to network resources and the processing resources of this packet processing node.

### 2. Example

Hereinafter, a description will be given of a communication system in a network using OpenFlow technology, as an example of the present invention.

### 2.1) Network Architecture

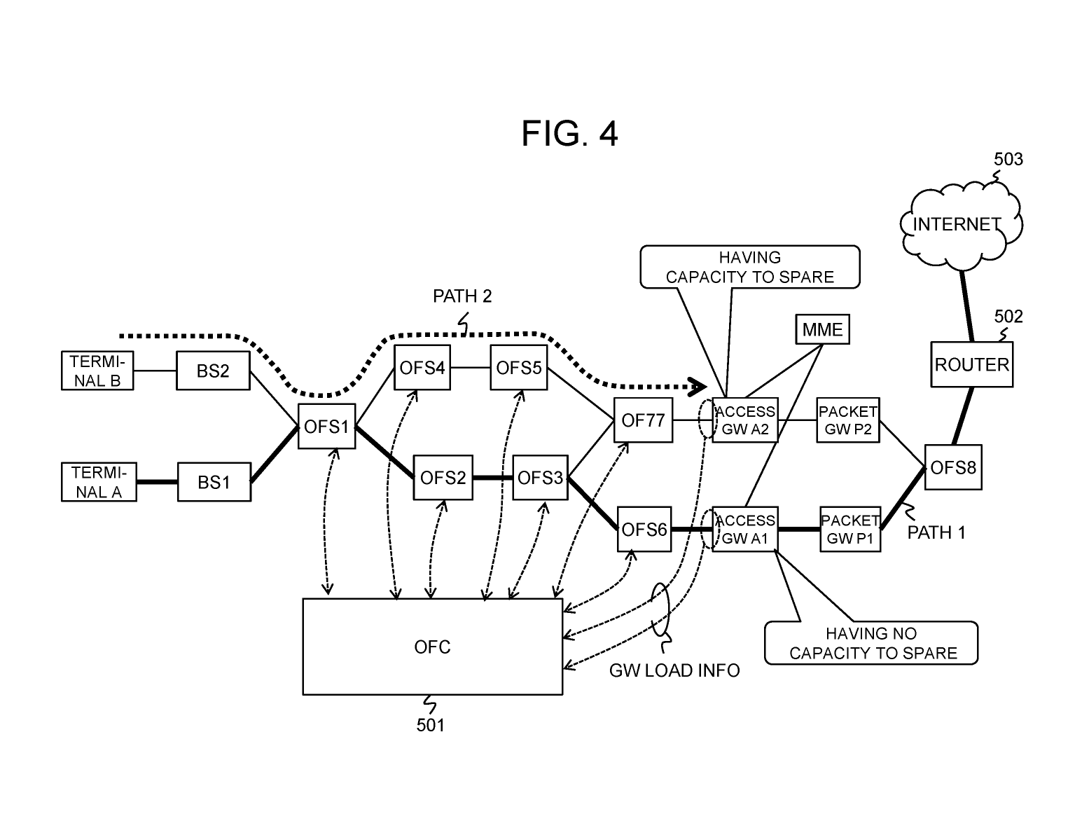

Referring to FIG. 4, it is assumed that an OpenFlow controller 501 controls OpenFlow switches OFS1 to OFS8 and further has a routing function according to the present example. However, it is assumed here as an example that path load information of the OpenFlow switches OFS1 to OFS7 and load information of access gateways A1 and A2 are collected by the OpenFlow controller 501. Note that an OpenFlow secure channel can be used for communication of information between each of OFSs and access gateways and the OpenFlow controller 501, and protocols such as SNMP (Simple Network Management Protocol) and LLDP (Link Layer Discovery Protocol) can be also used.

Note that the OFS can operate as an ordinary Layer 2 switch or an OFS. In other words, the OFS can implement an ordinary Layer 2 switch within its own mechanism. Moreover, when operating as an ordinary Layer 2 switch, the OFS is deployed in the network and performs switching of a received frame by using an L2 address. When operating as an OFS, the OFS acquires routing information from the OFC beforehand and operates based on this information.

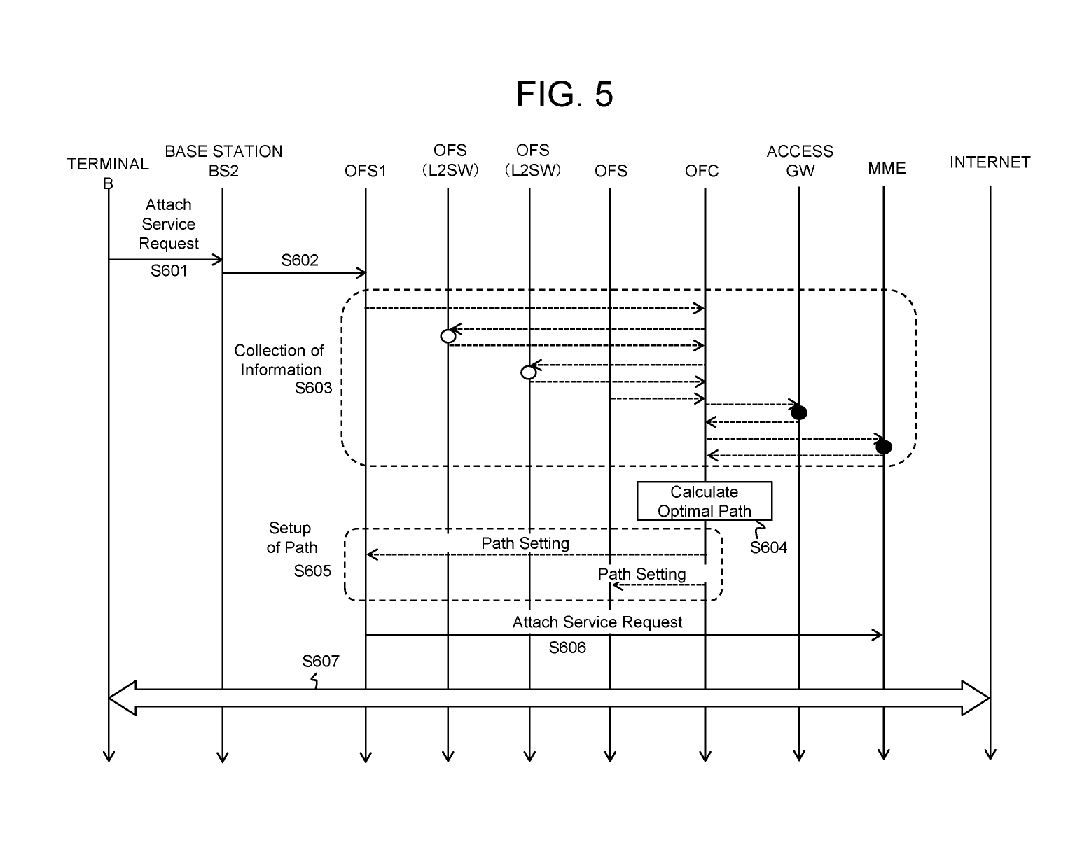

Moreover, in the network shown in FIG. 4, a redundant system is configured between terminals A and B and the Internet 503, wherein a path passing via OFS2 and OFS3 and a path passing via OFS4 and OFS5 exist between the OpenFlow switches OFS1 and OFS7, and a path passing via OFS6, the access gateway A1 and a packet gateway P1 and a path passing via OFS7, the access gateway A2 and a packet gateway P2 exist between the OpenFlow switches OFS3 and OFS8. Here, it is assumed that a path passing via OFS2 and the access gateway A1 is referred to as PATH1, and that the terminal A is connected to a router 502 and the Internet 503 through this PATH1. Moreover, it is assumed that the access gateway A1 is under a heavier processing load, while the access gateway A2 is under a lighter processing load. A description will be given of operation in case where the terminal B makes a connection request in this state, with reference to FIG. 5.

### 2.2) Operation

Referring to FIG. 5, when the terminal B sends an attach service request to a base station BS2 (Operation S601), the base station BS2 forwards the attach service request to OFS1 (Operation S602). Triggered by the arrival of the new request at the OFS1, the OFC 501 collects network loads from each OFS and collects processing loads from packet processing nodes such as the access gateways and a mobility management node (MME) as described above (Operation S603). The OFC 501 calculates an optimum path from OFS1 up to the MME by using the collected load information (Operation S604). Here, it is assumed that, with consideration given to the network loads and the processing loads of the access gateways, the PATH2 is calculated as an optimum path so that the overall resource efficiency will be maximized, as shown in FIG. 4.

The OFC 501 performs path setting on OFS1, OFS4, OFS5 and OFS7 so that the PATH2 will be set up (Operation S605), whereby OFS1 transfers the attach service request to the MME through the PATH2 (Operation S606). Thus, communication becomes enabled between the terminal B and the Internal 503 (S607).

### 2.3) Effects

As described above, according to the present example of the present invention, the OpenFlow switches OFS serve as routing nodes, the access gateways serve as packet processing nodes or servers, and the OpenFlow controller 501 serves as a upper-level control apparatus 30, whereby it is possible to perform load balancing taking consideration of both the state of the loads on the OFSs and the state of the processing loads on the access gateways. Thereby, it is possible to preferentially assign a path and a server under lighter loads, resulting in the reduced path delay and processing delay of each packet.

### INDUSTRIAL APPLICABILITY

The present invention can be applied to routing in a network structured based on OpenFlow.

### REFERENCE SIGNS LIST

10 Network
20 Packet processing node
30 Upper-level control apparatus
N1-N5 Routing node

1. A communication system comprising:
a plurality of network nodes, each of which is capable of receiving a packet that is transmitted by a terminal;
at least one processing node that is configured to process the packet; and
a control apparatus that is configured to calculate forwarding path of the packet in the network based on network load information collected from the network nodes and processing load information collected from the at least one processing node, and to perform path setting on network nodes to set up the forwarding path.

2. The communication system according to claim 1, wherein the network nodes measure and store the network load information, the at least one processing node measures and stores the processing load information, and the control apparatus collects the network load information and the processing load information from the network nodes and the at least one processing node, respectively.

3. The communication system according to claim 1, wherein each of the network nodes is a switch that forwards an arriving packet according to the routing function, and the control apparatus is a controller that controls a forwarding function of the switch.

4. A control apparatus in a network, by comprising:
a storage unit for storing network load information collected from a plurality of network nodes, each of which is capable of receiving a packet that a terminal has sent, and processing load information collected from at least one processing node, which processes the packet; and
a controller that is configured to calculate a forwarding path of the packet in the network based on the network load information and the processing load information, and to performs path setting on network nodes to set up the forwarding path.

5. The control apparatus according to claim 4, wherein the network nodes measure and store the network load information, the at least one processing node measures and stores the processing load information, wherein the controller collects the network load information and the processing load information from the network nodes and the at least one processing node, respectively, to store them in the storage unit.

6. The control apparatus according to claim 4, wherein each of the network nodes is a switch that forwards an arriving packet according to the routing function, and the controller controls a forwarding function of the switch.

7. A communication method in a network that includes a plurality of network nodes, each of which is capable of receiving a packet that a terminal has sent, and at least one processing node that processes the packet, the communication method comprising:
at a control apparatus that controls the plurality of network nodes and the at least one processing node,
calculating forwarding path of the packet in the network based on network load information collected from the network nodes and processing load information collected from the at least one processing node; and
performing path setting on network nodes to set up the forwarding path.

8. The communication method according to claim 7, wherein the network nodes measure and store the network load information, the at least one processing node measures and stores the processing load information, and the upper-level control apparatus collects the network load information and the processing load information from the network nodes and the at least one processing node, respectively.

9. The communication method according to claim 7, wherein each of the network nodes performs packet forwarding by means of a switch that forwards an arriving packet according to the routing function, and the upper-level control apparatus controls a forwarding function of the switch.

10. (canceled)

11. The communication system according to claim 1,
wherein the at least one processing node is at least one access gateway that performs processing the packet.

12. The communication system according to claim 11, further comprising a mobility management node that manages the at least one access gateway,
wherein the control apparatus is configured to collect the processing load information of the at least one access gateway from the mobility management node.

13. The communication system according to claim 11, wherein, responsive to receiving an attach service request that the terminal has sent via a base station, one of the network nodes makes a request of the control apparatus to set up a forwarding path through which the attach service request is to be forwarded,
wherein the control apparatus, responsive to receiving the request, calculates the forwarding path for the attach service request and performs path setting on network nodes to set up the forwarding path.

14. The control apparatus according to claim 4,
wherein the at least one processing node is at least one access gateway, which processes the packet.

15. The control apparatus according to claim 14, wherein the storage unit stores the processing load information of the at least one access gateway, wherein the processing load information is collected from a mobility management node that manages the at least one access gateway.

16. The control apparatus according to claim 14, wherein, responsive to being made of to set up the forwarding path for an attach service request that the terminal has sent via a base station, the controller calculates the forwarding path for the attach service request and performs path setting on the network nodes to set up the forwarding path.

17. The communication method according to claim 7, wherein the at least one processing node is at least one access gateway, which processes the packet.

18. The communication method according to claim 17, wherein the processing load information of the at least one access gateway is collected from a mobility management node that manages the at least one access gateway.

19. The communication method according to claim 17, wherein, responsive to being made of to set up the forwarding path for an attach service request that the terminal has sent via a base station, the control apparatus calculates the forwarding path for the attach service request and performs path setting on the network nodes to set up the forwarding path.
